(19) United States
(12) Patent Application Publication
(10) Pub. No.: US 2008/0115364 A1
(43) Pub. Date: May 22, 2008

(54) Headliner with Weakened Area and Method of Making Same

(76) Inventors: Gary Thomas Eichler, Novi, MI (US); Michael Eugene Pelchat II, Shelby Twp., MI (US); Andre Joseph Verellen, Kitchener (CA)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 12/023,764

(22) Filed: Jan. 31, 2008

Related U.S. Application Data
(62) Division of application No. 11/046,168, filed on Jan. 28, 2005, now abandoned.

(51) Int. Cl. B21D 53/88; B60J 7/00

(52) U.S. Cl. 29/897.2; 296/214; 29/428

(57) ABSTRACT

A method of manufacturing an interior trim panel disposable proximate vehicular sheet metal includes the steps of forming a multi-layer headliner by providing a substrate that includes a front surface, a back surface opposite the front surface, and a substrate thickness bound by the front and back surfaces; forming at least one slit that completely extends through the substrate, wherein the at least one slit defines at least one first opening in the substrate, and at least one second opening in the substrate, wherein the at least one first opening is formed in the front surface, wherein the at least one second opening is formed in the back surface; and concealing the at least one first opening by providing a covering adjacent the front surface.

### CROSS REFERENCE TO RELATED APPLICATIONS

This application is a divisional of U.S. patent application Ser. No. 11/046,168 filed on Jan. 28, 2005, titled “HEADLINER WITH WEAKENED AREA AND METHOD OF MAKING SAME”, which is incorporated herein by reference.

### TECHNICAL FIELD

The present invention generally relates to a weakened vehicle interior trim piece, and in particular to a weakened headliner for ease in airbag deployment and to a method of making the same.

### BACKGROUND OF THE INVENTION

Airbag safety systems are widely used in automotive vehicles and generally comprise an inflatable cushion, folded in an airbag receptacle. The airbag receptacle is typically mounted behind an airbag deployment door on an interior trim piece, such as an instrument panel, steering wheel column, headliner, or the like. Vehicles today typically include driver side airbags, front passenger airbags, side impact airbags, headliner airbags, knee airbags, and rear passenger airbags; consequently, airbag receptacles are mounted to several interior trim pieces.

The airbag must be able to rapidly deploy when the vehicle is in a collision. Therefore, the airbag must be able to force open the airbag deployment door when the airbag is inflated during deployment. To ease opening of the airbag deployment door, the trim piece in front of the airbag receptacle is weakened. Weakening of the trim piece is carried out by creating scored lines, or otherwise removing material, from the back surface of the trim piece. The scored lines form the perimeter of the deployment door.

A critical component of the weakening process is the amount of the trim piece material removed, or in other words, the amount of material remaining after being weakened. Enough material must be removed to weaken the trim piece and allow for airbag deployment, however, care must be taken to prevent removal of too much material. Removal of too much material from the trim piece may negatively effect the dimensional, or structural integrity of the trim piece and the aesthetic appearance of the trim piece.

In the case of headliners, maintaining structural integrity and aesthetic appearance of the part provides many challenges. Headliners are one of the largest trim pieces in the vehicle, thus the sheer size of the headliner presents difficulties in maintaining its structural integrity, even without the addition of areas of weakness. However, headliners conceal or hide, among other components, airbags, including side airbags that deploy from the roof rail. Consequently, it is necessary to weaken the headliner in several locations. In addition to the areas of weakness, headliners require apertures for overhead compartment bins, lighting, and entertainment devices, to name a few. The passengers' attention is drawn to the headliner whenever a component is utilized. The end result is that maintaining the structural integrity and aesthetic appearance of the headliner is very crucial and complicated.

FIGS. 5 and 6 illustrate a conventional headliner 100 comprising a substrate 110 and a decorative cover 120. The substrate 110 is weakened by partially scoring the substrate 110 with a groove 130. In efforts to maintain the structural integrity of the headliner while providing weakened areas for airbag deployment, the scored lines only partially penetrate the substrate 110 of the headliner 100.

### SUMMARY OF THE INVENTION

The inventors of the present invention have recognized these and other problems associated with maintaining structural stability of a headliner while providing a weakened area for airbag deployment. To this end, the inventors have unexpectedly developed a headliner comprising a substrate having a weakened area, the weakened area defined by at least one slit that completely penetrates through the substrate; and a decorative cover adhered to the substrate. A method of manufacturing a headliner with a weakened area, comprising the steps of forming a substrate, weakening the substrate by forming at least one slit that completely penetrates through the substrate, and concealing the substrate with a decorative covering.

### BRIEF DESCRIPTION OF THE DRAWINGS

FIG. 1 is a perspective view of the interior of a vehicle, including a headliner, in accordance with an exemplary embodiment of the invention.

FIG. 2 is an exploded view of a back surface of the headliner according to an exemplary embodiment of the present invention.

FIG. 3 is a cross-sectional view of the headliner taken along line 3-3 of FIG. 2.

FIG. 4A is a cross-sectional, partially assembled view of a headliner and a component referenced from line 4 of FIG. 1;

FIG. 4B is a cross-sectional, assembled view of the headliner and component according to line 4 of FIG. 1;

FIG. 5 is a partial view of a back surface of a substrate, with an airbag deployment door created by partially scoring the substrate, of a conventional headliner.

FIG. 6 is a cross-sectional view of the back surface of the substrate taken along line 6-6 of FIG. 5.

### DETAILED DESCRIPTION

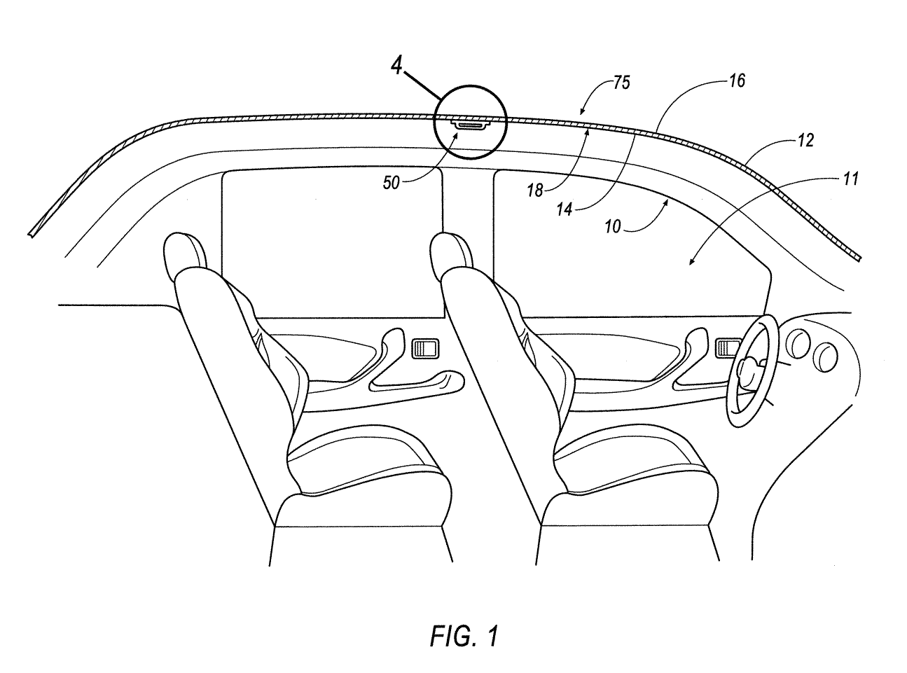

Referring to FIG. 1, a multilayer headliner 10 within a vehicle 11 is generally shown. The headliner 10 includes a substrate 12 having a front surface 14, or a Class “A” surface, that faces the interior of the vehicle, and a back surface 16, or a Class “B” surface, that faces away from the interior of the vehicle 11. A coverstock or decorative covering 18 may be adhered to the front surface 14 of the substrate 12 to conceal the substrate 12 for aesthetic purposes. The decorative covering 18 may be adhered to the substrate 12 through conventional means and may be comprised of cloth, leather, vinyl, or any other type of decorative covering. In the illustrated embodiment, the substrate 12 and decorative cover 18 form the multilayer headliner 10. However, the multilayer headliner 10 may include other layers of material, such as a foam layer disposed between the substrate 12 and the decorative cover 18.

The substrate 12 may be made from a thermoset material, such as, for example, foam or crushed urethane material, also known as polyurethane. The thermoset material may be a composite material and therefore, include reinforcements, such as, strands of fiber glass. Alternatively, the substrate 12 may be made from crushed and reinforced cardboard material, commonly sold as F10™, or the like.

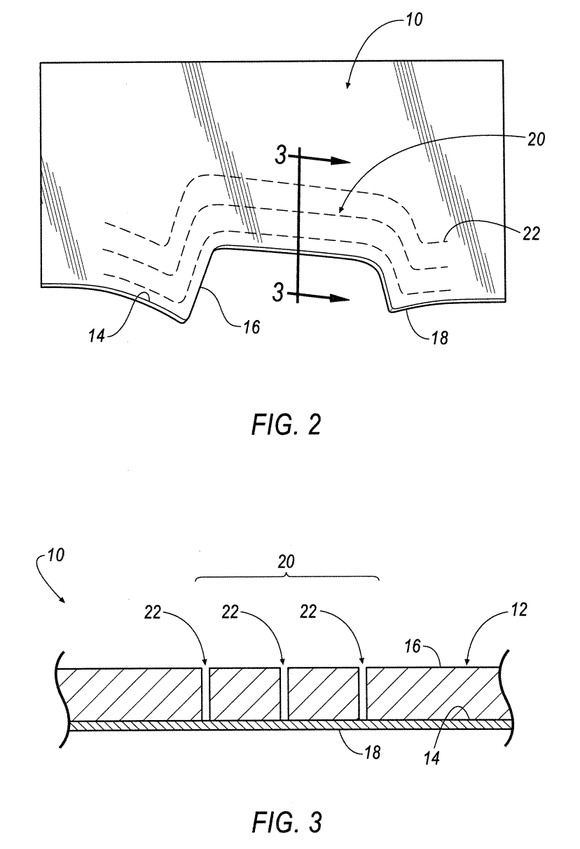

Referring to FIGS. 2 and 3, the substrate 12 includes a weakened area indicated generally at 20. The weakened area 20 reduces the strength of the substrate 12, including the yield strength of the substrate 12, in the general locality of the weakened area 20. The weakened area 20 comprises one or more slits 22 cut entirely through the substrate 12. The slits 22 completely penetrate the substrate 12, as shown in FIG. 3. The substrate 12 may be unexpectedly and completely pierced by slits 22 because of the material properties of the thermoset material.

The weakened area 20, defined by the pattern of dashed lines, forms an area of deployment for an airbag (not shown). In the exemplary embodiment, the slits 20 form a pattern of dashed lines at one or more desired locations, such as, around a portion or all of the perimeter of the substrate 12. However, it can be appreciated that the slits 22 can form any configuration of dashed lines on the substrate 12, so long as the substrate 12 is sufficiently weakened to allow proper deployment of the airbag. It has been found unexpectedly that weakening the substrate 12 by completely penetrating the substrate 12 with slits 22 sufficiently weakens the substrate 12 for deployment of the airbag. However, quite unexpectedly, the structural integrity of the substrate 12 is not compromised by completely penetrating the substrate 12 with slits 22. Once the decorative cover 18 is adhered to the substrate 12, the slits 22 are not visible to passengers in the vehicle, thus, completely penetrating the substrate 12 with slits 22 does not effect the aesthetic appearance of the substrate 12.

The substrate 12 may be manufactured using several different processes depending upon the material composition of the substrate 12. For example, the substrate 12 may be manufactured by an extrusion process, an injection molding process, a low compression molding process, a melt compression molding (MCM) process, or the like. For illustrative purposes, the substrate 12 is manufactured using a conventional injection molding process. After one cycle of the injection molding process, the substrate 12 undergoes a secondary trimming process. The secondary trimming process may include, for example, water jet trimming, laser beam trimming, die cut trimming, or the like.

In one method of manufacturing the substrate 12, the secondary trimming process includes undergoing trimming of the substrate 12 in a water jet trimming machine (not shown). The water jet trimming machine includes, among other components, a robotic arm having a water jet head (not shown) and a computer (not shown). The computer may be programmed to move the robotic arm in any configuration and to supply the water jet head with pressurized water at selective intervals. During the water jet trimming process, the water jet head is programmed to remove any excess flash around the perimeter of the substrate 12. During this secondary process, the slits 22 in the substrate 12 may also be cut, thereby eliminating a separate process needed to form the weakened area 20.

Once the substrate 12 has finished the secondary trimming process, the decorative cover 18 may be adhered to the front surface 14 of the substrate 12, thus forming the headliner 10. The decorative covering 18 conceals the slits 22 in the substrate 12. Therefore, the slits 22 are not visible to occupants of the vehicle 11 and do not effect the aesthetic appearance of the headliner 10.

In an alternate method of manufacturing the substrate 12, the slits 22 may be molded into the substrate 12 during the injection molding process. In other words, the slits 22 are in-molded into the substrate 12. After the substrate 12 and slits 22 are manufactured, the substrate 12 may further undergo the secondary trimming process to remove any flash or excess material. After the secondary trimming process, the decorative cover 18 may be adhered to the front surface 14 of the substrate 12, thus forming the multilayer headliner 10. As before, the decorative covering 18 conceals the slits 22 in the substrate 12. Therefore, the slits 22 are not visible to occupants of the vehicle 11 and do not effect the aesthetic appearance of the headliner 10. It can be appreciated that the slits 22 in the substrate 12 can be formed using other means known to those skilled in the art. For example, the slits 22 can be formed using a laser, or the like.

During airbag deployment, the airbag deploys in the vicinity of the weakened area 20. The weakened area 20, defined by the pattern of dashed lines, acts an airbag deployment door. The slits 22 may also perform the function of a hinge, a pivot, an axis, or the like between the substrate 12 and the weakened area 20 of the substrate 12. When the airbag deploys, the weakened area 20 of the substrate 12 gives way to the airbag, due to the forces exerted by the airbag against the substrate 12. The substrate 12, along with the decorative cover 18, breaks apart at the weakened area 20, forming an aperture or door for the deployed airbag. The pieces of the substrate 12 that broke apart remain adhered to the decorative cover 18, thereby protecting the passengers from any broken pieces of the substrate 12.

It can be appreciated that the substrate 12 may be made from any material and by any manufacturing process, so long as the substrate 12 and the decorative covering 18 form the multilayer headliner 10 with the decorative covering 18 being adhered to the substrate 12 during a separate manufacturing process.

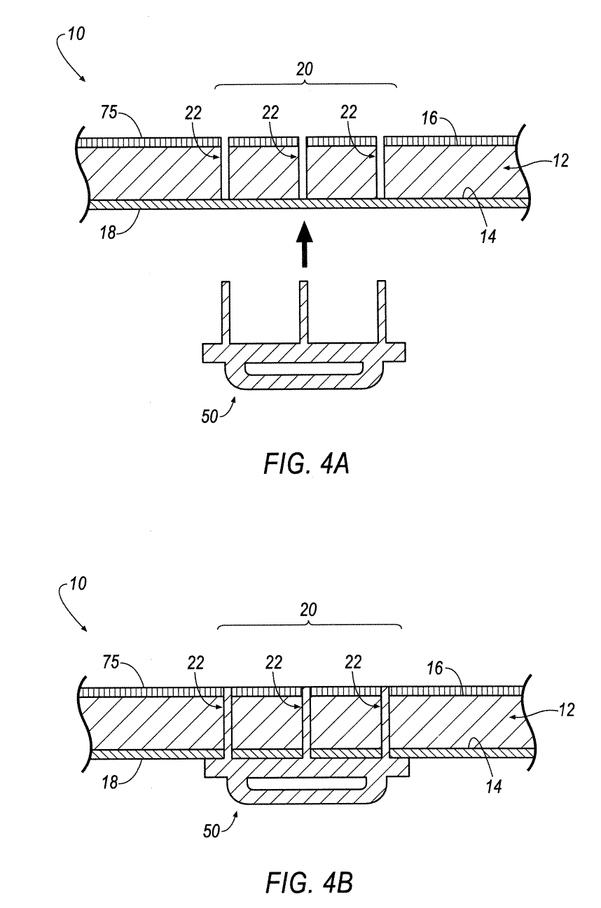

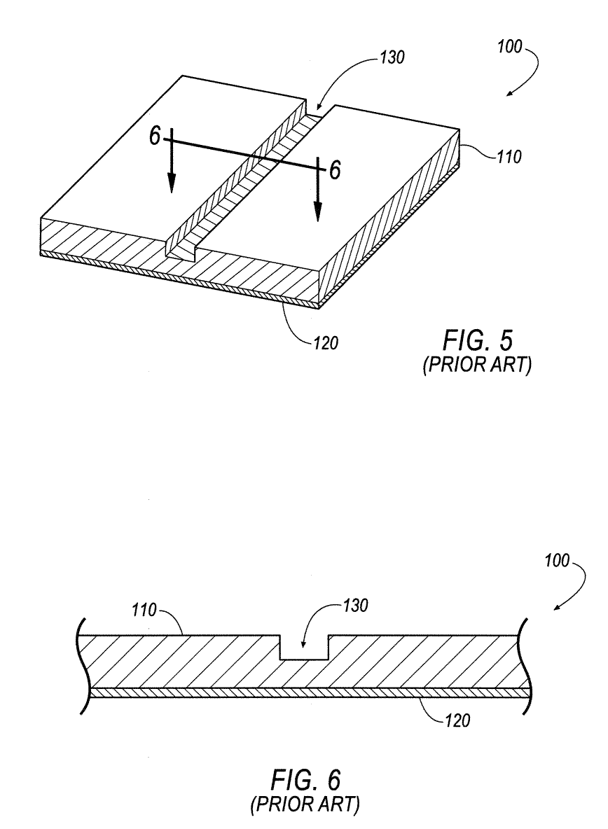

It can be appreciated that while the exemplary embodiment of the invention is directed towards weakening the substrate 12 for purposes of airbag deployment, the substrate 12 may be weakened for any number of reasons. For instance, the headliner 10 may be weakened in specific locations 20 for the addition of aftermarket products, such as, supplementary lighting in the interior of the vehicle. In other instances, as shown in FIGS. 4 and 5, for example, the substrate 12 may be weakened in areas 20, which is concealed by the covering 18, such that no visible apertures are seen formed in the headliner 10 by a passenger located in the passenger compartment of the vehicle. For example, the substrate 12 may be weakened at a desired mounting location of an interior trim component, such as, for example, one or more assist grips 50. During assembly, the assist grip 50 may pierce through the decorative covering 18 and pass through the weakened location 20 of the substrate 12 to permit subsequent attachment of the assist grip 50 to sheet metal 75 of the vehicle.

The embodiments disclosed herein have been discussed for the purpose of familiarizing the reader with novel aspects of the invention. Although preferred embodiments of the invention have been shown and described, many changes, modifications and substitutions may be made by one having ordinary skill in the art without necessarily departing from the spirit and scope of the invention as described in the following claims.

What is claimed is:

1. A method of manufacturing an interior trim panel disposable proximate vehicular sheet metal, comprising the steps of:
forming a multi-layer headliner by
providing a substrate that includes
a front surface,
a back surface opposite the front surface, and
a substrate thickness bound by the front and back surfaces;
forming at least one slit that completely extends through the substrate,
wherein the at least one slit defines
at least one first opening in the substrate, and
at least one second opening in the substrate, wherein the at least one first opening is formed in the front surface, wherein the at least one second opening is formed in the back surface; and
concealing the at least one first opening by
providing a covering adjacent the front surface.

2. The method according to claim 1, wherein the providing a covering adjacent the front surface step includes
adhering the covering adjacent the front surface.

3. The method according to claim 1 further comprising the steps of
providing a component;
piercing the covering with the component;
passing the component through the at least one slit; and
attaching the component to the vehicular sheet metal.

4. The method according to claim 1, wherein the forming the at least one slit step includes
trimming the substrate with a water jet.

5. The method according to claim 1, wherein the forming the at least one slit step includes
trimming the substrate with a laser.

6. The method according to claim 1, wherein the forming the at least one slit step includes
in-molding the at least one slit into the substrate.

7. The method according to claim 1 further comprising the step of
reinforcing the substrate.

8. The method according to claim 7 further comprising the step of
defining the substrate to include a reinforced thermoset material.

9. The method according to claim 7 further comprising the step of
defining the substrate to include crushed urethane.

10. The method according to claim 7 further comprising the step of
defining the substrate to include fiber glass strands.

11. The method according to claim 7 further comprising the step of
defining the substrate to include crushed and reinforced cardboard.

12. A method of manufacturing an interior trim panel disposable proximate vehicular sheet metal, comprising the steps of:
manufacturing a multi-layer headliner by
extruding a substrate material;
defining the extruded substrate material to include
a front surface,
a back surface opposite the front surface, and
a substrate thickness bound by the front and back surfaces;
forming at least one slit that completely extends through the substrate,
wherein the at least one slit defines
at least one first opening in the substrate, and
at least one second opening in the substrate, wherein the at least one first opening is formed in the front surface, wherein the at least one second opening is formed in the back surface; and
concealing the at least one first opening by
adhering a covering adjacent the front surface.

13. The method according to claim 12 further comprising the steps of
providing a component;
piercing the covering with the component;
passing the component through the at least one slit; and
attaching the component to the vehicular sheet metal.

14. The method according to claim 12, wherein the forming the at least one slit step includes
trimming the substrate with a water jet.

15. The method according to claim 12, wherein the forming the at least one slit step includes
trimming the substrate with a laser.

16. The method according to claim 12, wherein the forming the at least one slit step includes
in-molding the at least one slit into the substrate.

17. A method of manufacturing an interior trim panel, comprising the steps of:
providing a multi-layer headliner by
extruding a substrate material;
defining the extruded substrate material to include
a front surface,
a back surface opposite the front surface, and
a substrate thickness bound by the front and back surfaces;
forming at least one slit that completely extends through the substrate,
wherein the at least one slit defines
at least one first opening in the substrate, and
at least one second opening in the substrate, wherein the at least one first opening is formed in the front surface, wherein the at least one second opening is formed in the back surface;
concealing the at least one first opening by
adhering a covering adjacent the front surface;
disposing the multi-layer headliner proximate vehicular sheet metal;
providing an assist grip;
piercing the covering with a portion of the assist grip;
passing the portion of the assist grip through the at least one slit; and
attaching the portion of the assist grip to the vehicular sheet metal.

18. The method according to claim 17, wherein the forming the at least one slit step includes
trimming the substrate with a water jet.

19. The method according to claim 17, wherein the forming the at least one slit step includes
trimming the substrate with a laser.

20. The method according to claim 17, wherein the forming the at least one slit step includes
in-molding the at least one slit into the substrate.
